(19) United States
(12) Patent Application Publication
(10) Pub. No.: US 2013/0158741 A1
(43) Pub. Date: Jun. 20, 2013

(54) METHOD FOR ASSISTING DRIVER OF MOTOR VEHICLE GIVEN LOSS OF ALERTNESS

(71) Applicant: GM Global Technology Operations LLC, Detroit, MI (US)

(72) Inventor: Uwe HAHNE, Buettelborn (DE)

(73) Assignee: GM GLOBAL TECHNOLOGY OPERATIONS LLC, Detroit, MI (US)

(21) Appl. No.: 13/711,347

(22) Filed: Dec. 11, 2012

(30) Foreign Application Priority Data
Dec. 15, 2011 (DE) 102011121260.8

(51) Int. Cl. G06F 17/00

(52) U.S. Cl. CPC G06F 17/00
USPC 701/1

(57) ABSTRACT

A method for assisting the driver of a motor vehicle is provided. The method includes prescribing a desired driver behavior parameter that describes a desired driver behavior, determining an actual driver behavior parameter that describes an actual driver behavior, and determining a deviation parameter that describes a deviation between the desired driver behavior parameter and the actual driver behavior parameter. The method also includes prescribing a first threshold value for the deviation parameter, raising an error counter if the deviation parameter exceeds the first threshold value, and lowering the error counter if the deviation parameter falls below the first threshold value. The method includes determining an evaluation parameter that describes a change in the error counter over time, prescribing a lower threshold value for the evaluation parameter, and initiating a reaction that affects the behavior of the motor vehicle and/or driver if the evaluation parameter exceeds the lower threshold value.

### CROSS-REFERENCE TO RELATED APPLICATION

This application claims priority to German Patent Application No. 10 2011 121 260.8, filed Dec. 15, 2011, which is incorporated herein by reference in its entirety.

### TECHNICAL FIELD

The technical field relates to a method for assisting the driver of a motor vehicle, as well as to a motor vehicle for implementing the method.

### BACKGROUND

So-called assistance systems can be used for assisting drivers of a motor vehicle. These can intervene in the driving dynamics of the motor vehicle in a manner relevant to safety and/or influence a behavior of the driver of the motor vehicle, in particular by issuing warnings. Known are systems that evaluate driver alertness based on a prescribed desired behavior and a determined actual behavior of the driver. DE 10 2010 048 273 A1 relates to a method and driver assistance system for initiating a vehicle action as a function of alertness. The method here encompasses determining a vehicle position on a digital roadmap of a navigation system. In addition, a local vehicle environment is acquired in the form of environmental sensor data by at least one first vehicle sensor device, a local environmental map is generated from the environmental sensor data, and the vehicle position on the digital roadmap is reconciled with the local environmental map, wherein this yields a localized vehicle position that is detailed in terms of environmental information. A movement of the vehicle is then ascertained by at least one second vehicle sensor device, and the course of a road is identified from the digital roadmap of the navigation system based on the vehicle position, and an actual traveling route is finally determined from the localized vehicle position and movement of the vehicle, and the actual traveling route is compared with the desired traveling route, which is determined at least by the course of the road. Comparing the actual and desired traveling routes makes it possible to deduce the alertness of a driver and an alertness status value is assigned. After the alertness status value has been compared to a prescribed threshold value and found to deviate by a predetermined amount, the vehicle action is initiated. DE 10 2009 005 730 A1 relates to a method for monitoring the alertness of the driver of a motor vehicle involving the following steps: Determining an actual viewing direction, i.e., the direction in which the driver is looking, determining a desired viewing direction, i.e., the direction in which the driver should be looking to safely drive the motor vehicle, evaluating the actual viewing direction based on the desired viewing direction to ascertain the alertness or inattentiveness of the motor vehicle driver, determining an allotted timeframe within which an inattentiveness on the part of the motor vehicle driver can be tolerated, determining the duration of inattentiveness if an inattentiveness on the part of the motor vehicle driver has been ascertained, and comparing it to the allotted timeframe, alerting the driver if the duration has been exceeded, wherein the method is characterized in that the desired viewing direction and/or allotted timeframe are determined as a function of the position of a turn signal, information about the course of the road ahead of the motor vehicle, and/or information from a lane departure warning system.

Therefore it may be desirable to enable the highest possible level of safety at the lowest possible error rate by assisting the driver of a motor vehicle through alertness recognition, even for the various driving styles of potentially different drivers. In addition, other objects, desirable features and characteristics will become apparent from the subsequent summary and detailed description, and the appended claims, taken in conjunction with the accompanying drawings and this background.

### SUMMARY

According to various exemplary embodiments, provided is an error counter that is advantageously activated when the actual driver behavior of the driver deviates from his or her desired driver behavior. This also holds true at a specific frequency for a conventional driving style. The evaluation parameter is advantageously determined as a function of a change in the error counter over time, so that a change in the driver behavior of the driver can advantageously be ascertained, in one example, because he or she is fatigued or another activity that demands his or her attention has begun. The evaluation parameter is advantageously compared with the lower threshold, and the reaction is initiated as a function thereof only if the lower threshold has been exceeded. The reaction advantageously acts either directly on the behavior of the driver, so that the latter in one example refocuses his or her attention on his or her driving once again, and/or on the behavior of the motor vehicle, in one example for adapting to typical driver traits, such as driving styles, especially to adjust safety-relevant systems to the diminished alertness. Maximum safety is advantageously also enabled for various driving styles of potentially different drivers, while keeping the error rate as low as possible. The error rate can here be understood as the frequency of erroneously issued driver warnings and/or performed interventions and/or changes by/to driver assistance systems.

One exemplary embodiment of the method according to the present disclosure includes an upper threshold that is advantageously also prescribed. A determination is advantageously made of whether the evaluation parameter lies between the upper threshold and lower threshold. This can advantageously be regarded as a criterion for the deviating actual driver behavior on the part of the driver, but does not allow an inference of a loss in alertness. Involved here in one example, is a common deviation in the behavior of a driver, for example because the latter prefers a sporty driving style, and/or his or her ability is subject to fluctuation. In this case, the desired driver behavior parameter can advantageously be adjusted in such a way as to provide a greater correlation between the actual driver behavior and desired driver behavior. This advantageously makes it possible to achieve an adaptation to the altered driver behavior of the driver.

Another exemplary embodiment of the method includes a first threshold value that is advantageously adapted to the altered or deviating driver behavior. The driver of the motor vehicle can be regarded as part of a so-called man-in-the-loop control system, in one example, for controlling the longitudinal dynamics and/or transverse dynamics of the motor vehicle via inputs at a man-machine interface, in one example, a steering wheel and/or torque interface. In one example, a typical control task has to do with establishing a braking point before an obstacle and/or traffic signals based upon which the advantages will be exemplarily explained. Different drivers here exhibit varying qualities, which manifest themselves in the control quality. The drivers can here apply the brakes at a high level of deviation around the prescribed braking point, meaning often do so somewhat sooner or somewhat later. Adapting the first threshold advantageously enables an adaptation to the control quality of such a man-in-the-loop control system. An adaptation can advantageously be made to drivers who drive very accurately or inaccurately.

Another exemplary embodiment of the method includes that only the amount by which the desired driver behavior parameter differs from the actual driver behavior parameter is included in ascertaining driver alertness. As a result, deviations in both directions can advantageously be acquired. In one example, driver errors going in both directions are encountered given a loss in alertness, for example a braking point that is clearly too late or too early, a speed that is clearly too high, or a speed that is clearly too low, which can advantageously also be acquired through value computation, and are incorporated into the evaluation parameter.

Another exemplary embodiment of the method includes that a desired driving trajectory can advantageously be determined by means of driver assistance systems and/or navigation systems that are present anyway. A deviation in driving trajectory can advantageously be used as a criterion for a loss in alertness. In one example, this case can involve directional stability during straight line travel and/or cornering behavior. Alternatively or additionally, the braking point can advantageously be used while approaching the car in front, maintaining a distance from the car in front and/or stopping in front of traffic signs, for example, traffic signals, and thus be included in the evaluation parameter. In like manner, this can be accomplished by prescribing an acceleration, in one example, when entering into a curve, exiting a curve, driving through a curve, adjusting a distance from the car in front and/or leaving a traffic sign, for example a stop sign and/or traffic signals, such as intersection lights. In one example, a reaction time to a traffic signal light can be used to prescribe the desired driver behavior.

Another exemplary embodiment of the method includes that the viewing direction of the driver can be prescribed as the desired driver behavior. An early or late change in the view or viewing direction that is included in the evaluation parameter via the advantageous evaluation over time can advantageously provide information about the alertness of the driver of the motor vehicle.

Another exemplary embodiment of the method includes that the time and/or duration of the blinker can advantageously also provide information about the alertness of the driver of the motor vehicle, and be included in the evaluation parameter. In one example, forgetting to turn on the blinker can provide information about the alertness of the driver.

Another exemplary embodiment of the method includes that drivers of motor vehicles usually exhibit characteristic peculiarities when shifting the manual transmission of a motor vehicle. Shifting points that change or deviate from the desired driver behavior can advantageously also be used to calculate the evaluation parameter.

Another exemplary embodiment of the method includes that motorists usually follow the speed limits dictated by traffic signs by correspondingly braking or accelerating the vehicle. Given a diminishing alertness, the degree of compliance changes, in one example, toward faster speeds or slower speeds than prescribed by traffic rules. This circumstance can advantageously be included in the evaluation parameter. In one example, different drivers exhibit varying deviations relative to the prescribed speeds, for example drive basically somewhat slower or basically somewhat faster than prescribed. An adaptation can advantageously be made to this offset if accompanied by an evaluation parameter between the upper threshold and lower threshold. In cases where the deviations are only slight or arise only occasionally, the evaluation parameter advantageously remains under the lower threshold, so that no adaptation takes place.

Another exemplary embodiment of the method includes that in a motor vehicle with partially automated and/or automated operation, in particular a mode of operation that no longer requires that the driver of the motor vehicle have his or her hands on the steering wheel and/or feet on the pedals, driver reactions are still necessary, for example to respond to warnings or a so-called dead man's switch. These reactions can advantageously also be adapted with regard to the premises of the respective driver, and included in the evaluation parameter.

Another exemplary embodiment of the method includes that the driver can advantageously be warned as a function of the evaluation parameter, in one example, to restore his or her alertness again and/or induce him or her to take a break. Driving safety can advantageously be elevated in this way.

Another exemplary embodiment of the method includes that the upper threshold can advantageously be used to warn the driver. Alternatively or additionally, a warning threshold deviating from the upper threshold can also be established, wherein the driver is warned once the evaluation parameter has exceeded the warning threshold.

Another exemplary embodiment of the method includes that the motor vehicle advantageously exhibits additional assistance systems, which intervene in the driving dynamics of the motor vehicle and/or issue warnings to the driver. For example, these can be driving dynamics controllers, side slip angle controllers, longitudinal dynamics controllers, crash consequence alleviation systems, longitudinal controllers, distance controllers and/or the like. These systems have their own warning thresholds and/or intervention thresholds, wherein an actual state of the motor vehicle is usually compared with a desired state, and the intervention is made in the driving dynamics and/or a warning is issued to the driver based on an existing deviation that exceeds corresponding premises. To this end, existing warning thresholds and/or intervention thresholds of the respective driver assistance system can be adjusted as a function of the evaluation parameter, in particular so as to enable a faster and better response to the ascertained diminished alertness of the driver. Driving safety can advantageously be elevated in this way.

Another exemplary embodiment of the method includes that the warning threshold and/or intervention threshold can advantageously also be adjusted as a function of the upper threshold that is present anyway, or, as an alternative, advantageously be adjusted independently of the upper threshold as a function of the adjustment threshold.

The various aspects of the present disclosure is also achieved by means of a motor vehicle. The motor vehicle is set up, designed, constructed and/or outfitted with software for implementing a method described above. This yields the advantages described above.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flowchart for a method for assisting the driver of a motor vehicle.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

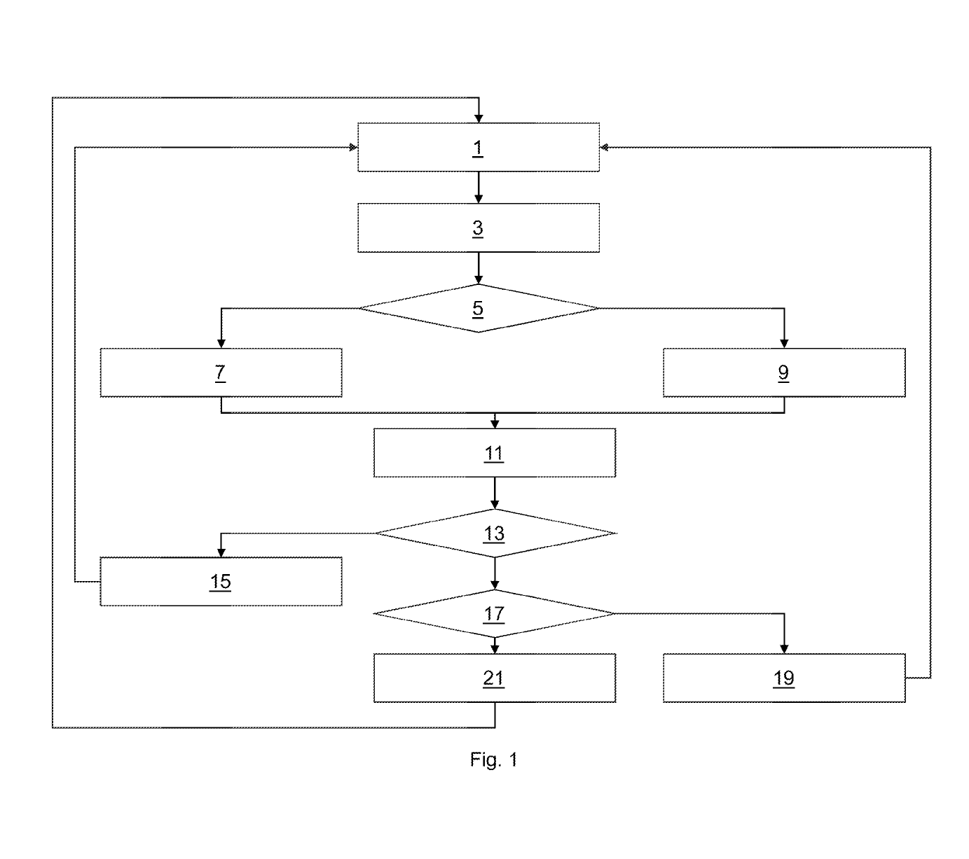

FIG. 1 shows a schematic progression of a method for supporting the driver of a motor vehicle. In 1, a desired driver behavior is ascertained for the driver of a motor vehicle. The desired driver behavior is described by a driver behavior parameter.

In one example, the desired driver behavior parameter is determined based on driver assistance systems already present in the motor vehicle anyway, especially driving dynamics controllers and/or navigation systems. In one example, this further takes place as a function of a given situation, for example straight line travel on a freeway, cornering on a country road, city driving, traffic flow, e.g., a traffic jam and/or free-flowing traffic and/or the like. In particular, a situation analysis is performed. For example, a division into situational classes can take place, which is kept available in a memory device of the motor vehicle, and can be called up as needed. In one example, the desired driver behavior can be provided with an initial value at the start of a driving cycle of the motor vehicle. In particular, the desired driver behavior involves a driving trajectory, a braking point, an acceleration, a viewing direction, a point and/or duration for turning on a blinker in the motor vehicle, a shifting point and/or shifting time for changing gears in the motor vehicle, a speed, in one example, a speed that depends on a traffic regulation, a driver reaction by the driver during the partially automated and/or automated operation of the motor vehicle and/or the like.

In 3, an actual driver behavior is determined for the driver of the motor vehicle, in one example, through measurement, for example, via sensors. Further, the actual driver behavior is compared with the desired driver behavior in the 3. Depending on the actual driver behavior, an actual driver behavior parameter that describes the later is determined

In a first comparison 5, a deviation of the actual driver behavior from the desired driver behavior, i.e., of the actual driver behavior parameter from the desired driver behavior parameter, is determined, and this deviation is compared with a first threshold value. In one example, the deviation involves the amount by which the desired driver behavior parameter differs from the actual driver behavior parameter. The difference between the actual driver behavior parameter and desired driver behavior parameter is calculated, wherein the amount of this difference yields a deviation parameter, which is compared with the first threshold during the first comparison 5.

In a case where the deviation parameter exceeds the first threshold value, the sequence branches into 7. An error counter is raised in 7.

In a case where the deviation parameter remains below the first threshold value, the sequence branches into 9, in which the error counter is lowered.

The blocks 7 and 9 both converge into 11.

A change in the error counter over time is determined in 11. To this end, an evaluation parameter describing this change over time is determined.

The block 11 converges into a second comparison 13.

The second comparison 13 prescribes an upper threshold value for the evaluation parameter. In a case where the evaluation parameter exceeds the upper threshold value, the sequence branches into 15.

Based on 15, it can be ascertained that the driver of the motor vehicle is unable to perform his or her driving task. The block 15 can advantageously be used to warn the driver. Alternatively or additionally, other assistance systems, for example lane departure warning systems, driving dynamics controllers and/or the like can be adjusted with the block 15. In one example, warning and/or intervention thresholds for intervening in the driving dynamics of the motor vehicle and/or warning the driver of the motor vehicle can be changed, especially lowered, thereby enabling a response by the driver assistance systems that is faster and adjusted to the diminishing alertness of the driver. Alternatively or additionally, another comparison can be provided before or after the second comparison 13, which compares the evaluation parameter with a warning threshold and branches to subsequently warning the driver and/or with an adjustment threshold and branches to subsequently adjusting the warning thresholds and/or intervention thresholds of the assistance systems.

The block 15 branches back to 1, so that the method is implemented cyclically, wherein the error counter can be cyclically raised or lowered in blocks 7, 9. If necessary, a cycle time can exhibit a sensible length, e.g., 5-10 seconds.

In a case where the evaluation parameter lies below the upper threshold value, the second comparison 13 branches into a third comparison 17.

The third comparison 17 stipulates a lower threshold value, and compares the evaluation parameter with it. In a case where the evaluation parameter lies below the lower threshold value, the third comparison branches into 19. The block 19 determines that the driver is able to perform his or her driving task, and also converges into 1.

In a case where the evaluation parameter exceeds the lower threshold value, the third comparison 17 branches into 21. The block 21 adjusts the desired driver behavior parameter of 1. This advantageously makes it possible to reduce the deviation parameter, wherein an adaptation can advantageously be made to the respective, in one example, sporty or defensive, driver behavior exhibited by the driver of the motor vehicle. Alternatively or additionally, the first threshold value can be adjusted for the deviation parameter of the first comparison 5. As a result, the method can advantageously be adjusted to a control quality of a so-called man-in-the-loop control circuit. The first threshold value can be reduced for especially precisely driving motorists. The first threshold value can advantageously be raised for somewhat less precisely driving motorists.

Alternatively or additionally, the desired driver behavior parameter and/or the first threshold value can also be adjusted and/or initialized and/or reset as a function of an operator parameter or operator input of the motor vehicle driver. In one example, the latter can enter that he or she feels fit and/or can prescribe various driver traits, especially sporty or defensive and/or the like.

In particular, the actual driver behavior parameter is acquired by means of environmental sensors and/or digital maps, wherein in one example, a situation analysis is performed, during which the anticipated desired driver behavior parameter is determined Driver assistance systems already present in the motor vehicle anyway, in particular autonomous longitudinal and/or transverse controllers, can advantageously be used to supply data for ascertaining the desired driver behavior parameter, especially planned trajectories and/or speed presets, in particular also when these assistance systems have been deactivated, wherein the latter advantageously continue to supply data in the background.

Given sustained deviations between the desired driver behavior parameter and actual driver behavior parameter, i.e., a sustained deviation parameter, it can alternatively or additionally be assumed that the driver of the motor vehicle exhibits another driving style. This can advantageously be recognized by means of the evaluation parameter, if the latter lies between the upper and lower threshold value, at which the advantageous adaptation takes place. The evaluation parameter denotes a change over time, and through comparison with the lower threshold value and/or upper threshold value and/or warning threshold and/or adjustment threshold can be used to advantageously react and potentially issue danger warnings and/or readjust or adapt the driver assistance systems.

In order to evaluate the desired driver behavior by comparison to the actual driver behavior, in one example, a reaction time of the driver can be evaluated based upon events transpiring in road traffic. In particular, it is possible to determine when the driver himself or herself starts to apply the brakes after environmental sensors have detected the braking of another vehicle, in particular a vehicle in front. The deviation parameter can advantageously be ascertained here as well. In one example, if the driver always reacts very late and abruptly to changing situations, the adaptation can advantageously take place, during which a so-called baseline can be adjusted.

Alternatively or additionally, the viewing direction of the driver can also be evaluated, in one example, via an inwardly directed camera, wherein a comparison is made with the traffic situation, making it possible to determine a desired viewing direction for the driver as a desired behavior parameter. In particular, the system expects that, when a vehicle in front brakes, the driver also looks forward. In particular, when vehicles that have just started to move over to their own lane are being passed at a higher speed, it can also be evaluated whether the driver is here directing his view toward the side lane. Viewing directions that deviate from this desired driver behavior can advantageously be included in the evaluation parameter.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for assisting a driver of a motor vehicle, comprising:
prescribing a desired driver behavior parameter that describes a desired driver behavior of the driver;
determining an actual driver behavior parameter that describes an actual driver behavior of the driver;
determining a deviation parameter that describes a deviation between the desired driver behavior parameter and the actual driver behavior parameter;
prescribing a first threshold value for the deviation parameter;
raising an error counter if the deviation parameter exceeds the first threshold value, and lowering the error counter if the deviation parameter falls below the first threshold value;
determining an evaluation parameter that describes a change in the error counter over time;
prescribing a lower threshold value for the evaluation parameter; and
initiating a reaction that affects the behavior of at least one of the motor vehicle and driver if the evaluation parameter exceeds the lower threshold value.

2. The method according to claim 1, further comprising:
prescribing an upper threshold value for the evaluation parameter; and
altering the desired driver behavior parameter if the evaluation parameter lies between the upper and lower threshold value as the reaction.

3. The method according to claim 2, further comprising:
altering the first threshold value as the reaction.

4. The method according to claim 3, further comprising:
determining the deviation parameter as the amount by which the desired driver behavior parameter differs from the actual driver behavior parameter.

5. The method according to claim 4, further comprising:
prescribing the desired driver behavior parameter as at least one of a driving trajectory, a braking point and an acceleration.

6. The method according to claim 5, further comprising:
prescribing the desired driver behavior parameter as viewing direction of the driver.

7. The method according to claim 6, further comprising:
prescribing the desired driver behavior parameter as at least one of a time and a duration for turning on a blinker of the motor vehicle.

8. The method according to claim 7, further comprising:
prescribing the desired driver behavior parameter as a shifting point for changing a gear of the motor vehicle.

9. The method according to claim 8, further comprising:
prescribing the desired driver behavior parameter as a speed prescribed by a traffic regulation.

10. The method according to claim 9, further comprising:
prescribing the desired driver behavior parameter as a driver reaction required given at least one of an at least partially automated operation and a reaction time for the required driver reaction.

11. The method according to claim 10, further comprising:
warning the driver as the reaction.

12. The method according to claim 11, further comprising:
warning the driver as the reaction if the evaluation parameter exceeds the upper threshold value or a warning threshold.

13. The method according to claim 12, further comprising:
adjusting at least one of a warning threshold and an intervention threshold of a driver assistance system of the motor vehicle as the reaction.

14. The method according to claim 13, further comprising:
adjusting at least one of the warning threshold and intervention threshold of the driver assistance system of the motor vehicle if the evaluation parameter exceeds the upper threshold value or an adjustment threshold.

15. A motor vehicle, comprising:
a driver assistance system that includes:
a means for determining a deviation parameter that describes a deviation between a desired driver behavior parameter and an actual driver behavior parameter;
a means for raising an error counter if the deviation parameter exceeds a first threshold value, and lowering the error counter if the deviation parameter falls below the first threshold value; and
a means for initiating a reaction that affects the behavior of at least one of the motor vehicle and driver if the evaluation parameter exceeds the lower threshold value.
